(19) United States
(12) Patent Application Publication
(10) Pub. No.: US 2006/0199457 A1
(43) Pub. Date: Sep. 7, 2006

(54) Cloth-like biaxial stretch nonwoven

(75) Inventors: Gregory K. Hall, Menasha, WI (US); Peiguang Zhou, Appleton, WI (US); Thomas Harold Roessler, Appleton, WI (US); Paul Theodore Van Gompel, Hortonville, WI (US)

Correspondence Address: KIMBERLY-CLARK WORLDWIDE, INC., 401 NORTH LAKE STREET, NEENAH, WI, 54956, US

(73) Assignee: Kimberly-Clark Worldwide, Inc.

(21) Appl. No.: 11/070,307

(22) Filed: Mar. 1, 2005

(51) Int. Cl. D04H 13/00; B32B 25/10; D04H 1/56

(52) U.S. Cl. 442/327; 442/400; 442/399

(57) ABSTRACT

An elastomeric composite web (20) includes an elastomeric-substrate (22), and an operative layer of an elastomeric polypropylene-based adhesive material (24) or other surface modifying agent which is adhered or otherwise applied directly to at least one major, facing-side (26) of the elastomeric-substrate (22). In particular aspects, the layer of the surface modifying agent (24) has been provided separate from the elastomeric-substrate (22), and the layer of surface modifying agent (24) has been applied directly to the elastomeric-substrate (22) while the elastomeric-substrate has been operatively configured in a substantially unstretched condition. In other aspects, the elastomeric-substrate (22) can have a distinctively high basis weight, and the layer of surface modifying agent (24) can be applied directly to the elastomeric-substrate (22) prior to attaching the elastomeric-substrate to any separately provided, substantially non-elastomeric, supplemental-substrate. In a further aspect, the elastomeric-substrate (22) can be substantially free of continuous, elastomeric strands.

### FIELD OF THE INVENTION

The present invention relates to an elastomeric composite web having enhanced stretchability. The invention also relates to manufacturing methods for making such elastomeric composite web. The elastomeric webs can be used on or in various personal care articles, as well as other articles that require a significant ability to stretch.

### BACKGROUND OF THE INVENTION

The term “stretch bonded laminate” has been employed to refer to a composite elastic material made according to a stretch bonding lamination process, i.e., elastic layer(s) are joined together with additional facing layers when only the elastic layer is in an extended condition (such by at least about 25 percent of its relaxed length) so that upon relaxation of the layers, the additional layer(s) is/are gathered. Such laminates usually have machine-directional (MD) stretch properties and may be subsequently stretched to the extent that the additional (typically nonelastic) material gathered between the bond locations allows the elastic material to elongate. One type of stretch bonded laminate is disclosed, for example, by U.S. Pat. No. 4,720,415 to Vander Wielen et al., in which multiple layers of the same polymer produced from multiple banks of extruders are used. Other composite elastic materials are disclosed in U.S. Pat. No. 5,385,775 to Wright and copending U.S. Patent Application Publication No. 2002-0104608, published 8 Aug. 2002, each of which is incorporated by reference herein in its entirety. Such stretch bonded laminates may include an elastic component that is a web, such as a meltblown web, a film, an array/series of generally parallel continuous filament strands (either extruded or pre-formed), or a combination of such. The elastic layer is bonded in a stretched condition to two inelastic or extendable nonwoven facing materials, such that the resulting laminate is imparted with a textural feel that is pleasing on the hand. In particular, the elastic layer is bonded between the two facing layers, such that the facing layers sandwich the elastic layer. In some instances, the gatherable facing layers may also be necked, such that the stretch bonded laminate is actually a necked stretch bonded laminate that may have some extension/elasticity in the cross-machine direction (CD).

The term “neck” or “necked” has referred to a process of tensioning a fabric in a particular direction thereby reducing the width dimension of the fabric in the direction perpendicular to the direction of tension. For example, tensioning a nonwoven fabric in the MD causes the fabric to “neck” or narrow in the CD and give the necked fabric CD stretchability. Examples of such extensible and/or elastic fabrics include, but are not limited to, those described in U.S. Pat. No. 4,965,122 to Morman et al. and U.S. Pat. No. 5,336,545 to Morman et al.; each of which is incorporated herein by reference in its entirety.

The term “Neck bonding” has referred to a process wherein an elastic member is bonded to a non-elastic member while only the non-elastic member is extended or necked so as to reduce its dimension in the direction orthogonal to the extension. “Neck bonded laminate” refers to a composite elastic material made according to the neck bonding process, i.e., the layers are joined together when only the non-elastic layer is in an extended/necked condition. Such laminates usually have cross-directional stretch properties. Further examples of neck-bonded laminates are such as those described in U.S. Pat. Nos. 5,226,992 and 4,981,747 to Morman; and U.S. Pat. No. 5,514,470 to Haffner et al.; each of which is incorporated herein by reference in its entirety.

“Neck-stretch bonding” has generally referred to a process wherein an elastic member is bonded to another member while the elastic member is extended (such as by about 25 percent of its relaxed length) and the other layer is a necked, non-elastic layer. “Neck-stretch bonded laminate” refers to a composite elastic material made according to the neck-stretch bonding process, i.e., the layers are joined together when both layers are in an extended condition and then allowed to relax. Such laminates usually have multi-directional stretch properties.

Such stretch bonded laminates have been used to provide elasticity to various components of a personal care product and with the added benefit of a pleasant fabric-like touch. Such components have included a diaper liner or outercover, diaper waist band material, diaper leg gasketing (cuff) material, diaper ear portions, (that is the point of attachment of a fastening system to a diaper), as well as side panel materials for diapers and child training pants. Since such materials have often come in contact with skin of a human body, it has been desirable that such materials be relatively soft to the touch, rather than rubbery in their feel (a tactile sensation that has been common for elastic materials). Such materials may likewise be employed to provide elasticity and comfort for materials that are incorporated into protective work wear, such as surgical gowns, face masks and drapes, laboratory coats, or protective outercovers, such as car, grill or boat covers.

While conventional web materials have been soft and stretchy, and have assisted in making the elastic web materials more user-friendly, there has been a continuing need for web materials that can provide improved biaxial stretch properties, and a better cloth-like, fabric feel. In this regard, there is a need for such materials that can be more efficiently and more economically produced while still providing desired levels of elastic stretch and gathering.

Many conventionally employed adhesives have been elastically stretchable, but have tended to retain some level of tackiness even after the adhesive has dried or cured. As a result of the residual tackiness, it has been necessary, at least with respect to filament, film, and web based, stretch bonded laminates, to utilize facings on both sides of a center elastic component (i.e. filament array), so as to avoid roll blocking during processing or storage. For the purposes of the present disclosure, the terms “roll blocking” and “roll sticking” will be used interchangeably, and will refer to the propensity of tacky films, tacky filament arrays or other tacky sheet materials to stick to themselves when the materials have been rolled up for storage, prior to final use. Such roll blocking may inhibit the processibility of the rolled material, and make it excessively difficult to unwind the rolled material during use in a manufacturing operation.

While it would be desirable to reduce the basis weight of the stretch bonded laminate such that the material is less costly and more flexible, it has been heretofore unclear how to eliminate the extra facing layer(s) without causing the rolled material to stick, if it is to be stored prior to use. As a result, there has been a continuing need for an elastomeric composite that demonstrates acceptable elastic performance, but is also capable of being stored on a roll without concern for roll blocking.

### BRIEF DESCRIPTION OF THE INVENTION

An elastomeric composite web includes an elastomeric-substrate, and an operative layer of an elastomeric polypropylene-based adhesive material or other surface modifying agent which is bonded directly to at least one major, facing-side of the elastomeric-substrate. In particular aspects, the layer of an elastomeric polypropylene-based adhesive material or other surface modifying agent has been provided separate from the elastomeric-substrate, and the layer of elastomeric polypropylene-based adhesive material or other surface modifying agent has been adhered or otherwise bonded directly to the elastomeric-substrate while the elastomeric-substrate has been operatively configured in a substantially unstretched condition. In other aspects, the elastomeric-substrate can have a high basis weight, and the layer of elastomeric polypropylene-based adhesive material or other surface modifying agent has been adhered directly to the elastomeric-substrate prior to attaching the elastomeric-substrate to any separately provided, substantially non-elastomeric, supplemental-substrate. In a further aspect, the elastomeric-substrate can be substantially free of continuous, elastomeric filament strands.

By incorporating its various aspects and features, the elastomeric composite web of the present invention can provide improved performance by eliminating one or more components in the composite and by adjusting the basis weights of the components. Such an improved composite web could be more efficiently used to elasticize selected portions of a desired end product. The elastomeric composite web could be more readily stretched and could more readily retract since there would be no drag of extra facing layers. The elastomeric composite web of the invention can provide for higher levels of retraction with lower weights of polymer, and is capable of being rolled for storage, and unwound from the roll when needed for use.

### BRIEF DESCRIPTION OF THE DRAWINGS

The invention will be better understood by reference to the following description of the invention taken in conjunction with the accompanying drawings, wherein:

FIG. 1 schematically illustrates a representative method of manufacturing an elastomeric composite web in accordance with the invention.

FIG. 2 illustrates a schematic, slightly-expanded, cross-sectional view of a representative elastomeric composite web made in accordance with the present invention.

FIG. 3 shows a partially cut-away, top plan view of a bodyside of a representative personal care product which employs the representative elastomeric composite web made in accordance with the present invention.

FIG. 4 is a representative, graphical comparison pertaining to the stress-strain cycle properties of the invention along its machine-direction.

FIG. 5 is a representative, graphical comparison pertaining to the stress-strain cycle properties of the invention along its cross-direction.

FIG. 6 is a representative, graphical comparison pertaining to the elongation properties of the invention along its machine-direction.

FIG. 7 is a representative, graphical comparison pertaining to the elongation properties of the invention along its cross-direction.

### DETAILED DESCRIPTION OF THE INVENTION

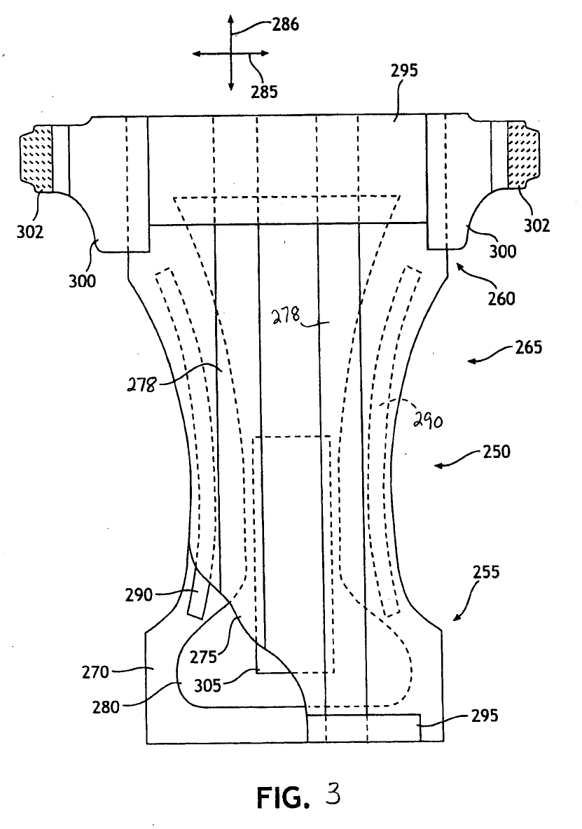

As used in the present disclosure, the term “personal care product” means infant diapers, children's training pants, swimwear, absorbent underpants, adult incontinence products, and feminine hygiene products, such as feminine care pads, napkins and pantiliners. While a diaper is representatively shown in FIG. 3, it should be recognized that the inventive material may just as easily be incorporated in any of the previously listed personal care products as an elastic component. For instance, such material may be utilized to make the elastic side panels of training pants.

As used herein the term “protective outerwear” means garments used for protection in the workplace, such as surgical gowns, hospital gowns, covergowns, labcoats, masks, and protective coveralls.

As used herein, the terms “protective cover” and “protective outercover” mean covers that are used to protect objects such as for example car, boat and barbeque grill covers, as well as agricultural fabrics.

As used herein, the terms “polymer” and “polymeric” when used without descriptive modifiers, generally include but are not limited to, homopolymers, copolymers, such as for example, block, graft, random and alternating copolymers, terpolymers, etc. and blends and modifications thereof. Furthermore, unless otherwise specifically limited, the term “polymer” includes all possible spatial configurations of the molecule. These configurations include, but are not limited to isotactic, syndiotactic and random symmetries.

As used herein, the term “machine-direction” (MD) means the direction along the length of a fabric in the direction in which it is produced. The term “cross-machine direction,” “cross-directional,” (CD) mean the direction across the width of fabric, i.e. a direction generally perpendicular to the MD.

As used herein, the term “nonwoven web” means a polymeric web having a structure of individual fibers or threads which are interlaid, but not in an identifiable, repeating manner. Nonwoven webs have been, in the past, formed by a variety of processes such as, for example, meltblowing processes, spunbonding processes, hydroentangling, air-laid and bonded carded web processes.

As used herein, the term “bonded carded webs” refers to webs that are made from staple fibers which are usually purchased in bales. The bales are placed in a fiberizing unit/picker which separates the fibers. Next, the fibers are sent through a combining or carding unit which further breaks apart and aligns the staple fibers in the machine-direction so as to form a machine-direction-oriented fibrous nonwoven web. Once the web has been formed, it is then bonded by one or more of several bonding methods. One bonding method is powder bonding wherein a powdered adhesive is distributed throughout the web and then activated, usually by heating the web and adhesive with hot air. Another bonding method is pattern bonding wherein heated calender rolls or ultrasonic bonding equipment is used to bond the fibers together, usually in a localized bond pattern through the web and or alternatively the web may be bonded across its entire surface if so desired. When using bicomponent staple fibers, through-air bonding equipment is, for many applications, especially advantageous.

As used herein the term “spunbond” refers to small diameter fibers which are formed by extruding molten thermoplastic material as filaments from a plurality of fine, usually circular capillaries of a spinneret, with the diameter of the extruded filaments being rapidly reduced, such as by methods and apparatus shown, for example, in U.S. Pat. No. 4,340,563 to Appel et al., and U.S. Pat. No. 3,692,618 to Dorschner et al., U.S. Pat. No. 3,802,817 to Matsuki et al., U.S. Pat. No. 3,338,992 to Kinney, U.S. Pat. No. 3,341,394 to Kinney, and U.S. Pat. No. 3,542,615 to Dobo et al., each of which is incorporated herein by reference in its entirety.

As used herein, the term “meltblown” means fibers formed by extruding a molten thermoplastic material through a plurality of fine, usually circular die capillaries as molten threads or filaments into converging high velocity gas (e.g. air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed, in various patents and publications; including NRL Report 4364, “Manufacture of Super-Fine Organic Fibers” by B. A. Wendt, E. L. Boone and D. D. Fluharty; NRL Report 5265, “An Improved Device For The Formation of Super-Fine Thermoplastic Fibers” by K. D. Lawrence, R. T. Lukas, J. A. Young; and U.S. Pat. No. 3,849,241, issued Nov. 19, 1974, to Butin, et al.; which are incorporated by reference hereto in their entirety.

As used herein, the terms “layer” and “layer material” are interchangeable, and in the absence of a word modifier, refer to woven or knitted fabric materials, nonwoven fibrous webs, polymeric films, polymeric scrim-like materials, discontinuous or substantially continuous distributions of fibrous or particulate materials, polymeric foam materials and the like.

The basis weight of nonwoven fabrics or films is usually expressed in ounces of material per square yard (osy) or grams per square meter (g/m² or gsm), and fiber diameters are usually expressed in micrometers or micro-inches. (Note that to convert from osy to gsm, multiply the osy value by 33.91). Film thicknesses may also be expressed in micrometers, micro-inches or mils.

As used herein, the term “laminate” refers to a composite structure of two or more material layers that have been adhered or otherwise bonded together, such as through adhesive bonding, thermal bonding, point bonding, pressure bonding, extrusion coating or ultrasonic bonding.

As used herein, the term “elastomeric” shall be interchangeable with the term “elastic” and refers to sheet material which, upon application of a stretching force, is stretchable in at least one direction, and which upon release of the stretching force contracts/returns to approximately its original dimension. For example, an elastomeric or elastic material can provide a stretched material which has a stretched length that is at least 50 percent greater than its base, relaxed, unstretched length, and which can recover or re-shorten by an amount that is at least 50 percent of its length-amount of induced stretching upon release of the stretching force. A hypothetical example would be a 1-inch sample of a material which is stretchable to at least 1.5 inches and which, upon release of the stretching force, can recover to a length that is not greater than 1.25 inches.

As used herein, the term “elastomer” shall refer to a polymer which is elastomeric.

As used herein, the term “thermoplastic” shall refer to a polymer which is capable of being melt processed.

As used herein, the term “inelastic” or “nonelastic” refers to any material which does not fall within the definition of “elastomeric” or “elastic” above.

As used herein, the term “ultrasonic bonding” means a process performed, for example, by passing the fabric between a high-frequency, sonic horn and an anvil roll, as described in U.S. Pat. No. 4,374,888 to Bornslaeger, which is incorporated herein by reference in its entirety.

As used herein, the term “adhesive bonding” means a bonding process which forms a bond by application of an adhesive. Such application of adhesive may be by various processes such as slot coating, spray coating and other topical applications. Further, such adhesive may be applied within a product component and then exposed to pressure such that contact of a second product component with the adhesive containing product component forms an adhesive bond between the two components.

As used in the specification and claims, the term “comprising” is inclusive or open-ended and does not exclude additional unrecited elements, compositional components, or method steps. Accordingly, such term is intended to be synonymous with the words “has”, “have”, “having”, “includes”, “including”, and any derivatives of these words.

As used herein, the terms “extensible” or “expandable” mean elongatable in at least one direction, but not necessarily recoverable towards its initial, non-elongated length.

Unless otherwise indicated, percentages of components in formulations are by weight.

As used herein, the term “surface modifying agent” (SMA) refers to a material which, when present on a substrate, can alter the softness or cloth-like feel of the substrate, alter the hydrophilicity or hydrophobicity of the substrate, and/or alter the MD or CD elastic properties of the substrate, as desired. The SMA may also be a material which, when present on the substrate, provides a coefficient of friction (COF) which differs from a COF of the substrate that is observed when the surface modifying agent is not present.

Test Method Procedures:

Stress-Strain Cycle Test

An elastic composite (laminate) sample of 3 inch wide and 6 inch long is placed in the clamps of a constant rate of extension (CRE) load frame, such as a SINTECH tensile tester, model SYNERGIE 200, which is commercially available from the MTS Systems Corporation, Eden Prairie, Minn., U.S.A. Starting at a 4 inch (10.2 cm) gauge length between the sample grips, the sample is elongated at a rate of 500 mm/min (approximately 20 inches/minute) to 100% elongation (8 inch (20.3 cm) jaw-span). The cross-head returns to the original 4 inch (10.2 cm) gauge length position to complete each cycle. Two full cycles to 100% elongation are preformed, followed by a third elongation to break or ultimate elongation. The data points are recorded and plotted in grams force on the Y-axis and % elongation on the X-axis. Percentage of set was determined as the percent elongation at which the specimen reaches zero load on the return portion (i.e. retraction) of the cycle. Testing was conducted at approximately 73° F. (about 23° C.) and about 50 percent relative humidity.

For percent hysteresis calculations, the data acquired was at a rate of 100 data points per cycle. The loading and unloading energy were calculated by integrating the area under the respective curves. The lower % hysteresis values correspond to better elastic efficiency of the composite measured. Percentage hysteresis was then calculated according to the following equation:
% Hysteresis=[(Loading Energy−Unloading Energy)/Loading Energy]×100.

Stress-Relaxation Test

An elastic composite (laminate) sample of 3 inch (7.6 cm) wide and 6 inch (15.2 cm) long is placed in the clamps of a constant rate of extension (CRE) load frame, such as a SINTECH tensile tester, model SYNERGIE 200, which is commercially available from the MTS Systems Corporation, Eden Prairie, Minn., U.S.A., or an equivalent apparatus. Starting at a 4 inch (10.2 cm) gauge length between the sample grips, the sample is elongated at a rate of 500 mm/min (approximately 20 inch/minute) to a 50% elongation (6 inch (15.2 cm) jaw span) and held for 30 minutes. The load data is recorded and plotted in grams force on the Y-axis and time in minutes on the X-axis. Testing was conducted at approximately 73° F. (about 23° C.) and about 50 percent relative humidity.

Stress-Strain Elongation to 2000 gram Test

An elastic composite (laminate) sample, which was 3 inch (7.6 cm) wide and 6 inch (15.2 cm) long, is placed in the clamps of a constant rate of extension (CRE) load frame, such as a SINTECH tensile tester, model SYNERGIE 200, which is commercially available from the MTS Systems Corporation, Eden Prairie, Minn., U.S.A., or an equivalent apparatus. Starting at a 4 inch (10.2 cm) gauge length between the sample grips, the sample is elongated at a rate of 500 mm/min. (approximately 20 inches/minute) until a 2000 g tension is reached or until sample material breaks, whichever occurs first. The data points are recorded and plotted in grams force on the Y-axis and % elongation on the X-axis. Testing was conducted at approximately 73° F. (about 23° C.) and about 50 percent relative humidity.

Coefficient of Friction (COF) Test:

Apparatus: TMI Lab Master Slip & Friction Model# 32-90-02 (Ser# 35312-01), which is available from Testing Machines, Inc., a business having offices located in Ronkonkoma, N.Y., U.S.A., or an equivalent apparatus;

Sled=200 grams (2.5×2.5 inch) (6.35 cm×6.35 cm).

Samples were prepared and fastened to the sled and tested against the metal surface of the test apparatus at the conditions described below

Units=none; COF is unit-less

Static Test Duration (time)=300 msec.

Kinetic Test Duration (distance)=0.5 cm-2.0 cm (3.81 cm)

Kinetic Test Speed=15.25 cm/min.

The COF test was performed using the guide rails to provide better reproducibility due to repetitive placement of the sled. The force of the sled was applied parallel to the machine direction of the material, and the samples were applied to the sled in a manner to minimize any slack in the test material.

Surface Tension Test

Surface energy characterizations of fibrous nonwoven webs were measured (on both the coated and the uncoated sides) by an independent laboratory, Augustine Scientific, which has offices located in Newbury, Ohio, U.S.A. Surface energies were measured by the Fowkes method using water and ethylene glycol as probe liquids (also called the sessile drop method). Ten drops for each of these liquids were placed on each surface and measured for contact angle using a KRUSS Drop Shape Analysis System DSA10, which is available from Kruss GmbH, a business having offices located in Hamburg, Germany. An equivalent system may optionally be employed. The resultant contact angle data were then used in combination with the Fowkes method of surface energy determination, which is described in detail in the following publication: Fowkes, F. M. “Attractive Forces At Interfaces”, Industrial & Engineering Chemistry, Vol. 56, No. 12, Pages 40-52 (1964).

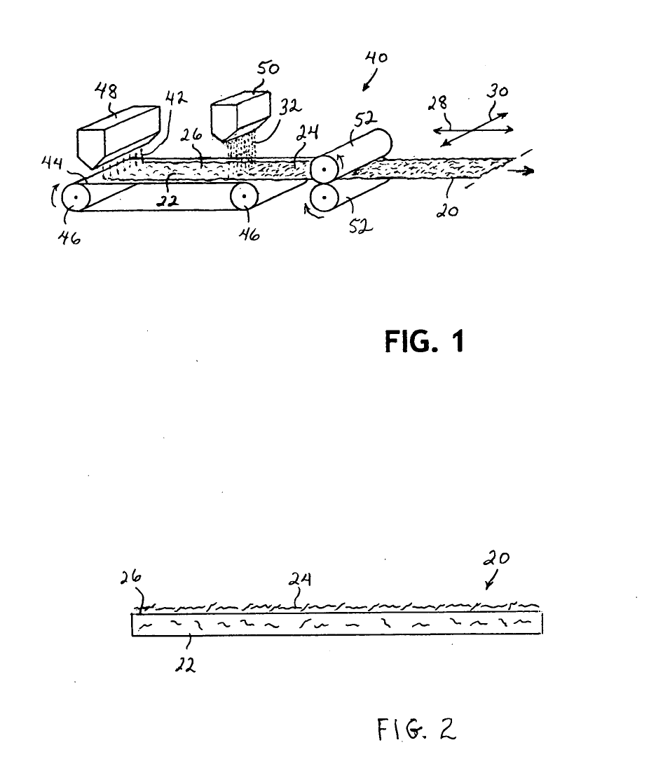

With reference to FIGS. 1 and 2, an elastomeric composite web 20 has a machine-direction 28, a cross-machine direction 30, and at least one major, facing-side 26. The machine-direction 28 extends longitudinally, and the cross-direction 30 which extends transversely. For the purposes of the present disclosure, the machine-direction 28 is the direction along which a particular component or material is or has been transported length-wise along and through a particular, local position of the employed apparatus and method. The cross-direction 30 lies generally parallel to the local horizontal, and is aligned perpendicular to the local machine-direction 28. The cross-direction may lie within the plane of the material being transported through the method and apparatus.

The elastomeric composite web 20 includes an elastomeric-substrate 22, and an operative layer of a surface modifying agent (e.g. an elastomeric polypropylene-based adhesive material 24) which is directly adhered or otherwise directly applied to the at least one major, facing-side 26 of the elastomeric-substrate. In particular aspects, the layer of surface modifying agent (e.g. elastomeric polypropylene-based adhesive material 24) has been provided separate from the elastomeric-substrate 22, and the layer of surface modifying agent (e.g. elastomeric polypropylene-based adhesive material 24) has been adhered or applied directly to the elastomeric-substrate 22 while the elastomeric-substrate has been operatively configured in a substantially unstretched condition. In another aspect, the layer of surface modifying agent (e.g. elastomeric polypropylene-based adhesive material 24) has been adhered directly to a primary elastomeric-substrate 22 prior to laminating or otherwise attaching the elastomeric-substrate to any separately provided, substantially non-elastomeric, supplemental-substrate. Additionally, the at least one major, facing-side of the elastomeric-substrate 22 can be an outward-facing side of the elastomeric-substrate. In a further aspect, the elastomeric-substrate 22 can be substantially free of continuous, elastomeric strands.

In a particular configuration of the invention, the elastic laminate or other elastomeric composite web 20 can include a meltblown deposited on the elastomeric-substrate 22. In alternative configurations of the invention, the meltblown surface modifying agent can, for example, include polyolefins, and elastomeric polymers with or without tackifiers. In desired configurations, the surface modifying agent can include a polypropylene-based adhesive.

By incorporating its various aspects and features, individually or in desired combinations, the elastomeric composite web 20 can have increased softness, a less rubbery or less sticky feel, and improved cloth-like properties. The composite web can also provide desired hydrophilicity or hydrophobicity properties, and/or desired elastic properties in its machine-direction and cross-direction.

The elastomeric composite web of the invention can be constructed by employing any operative method or technique. Such techniques are conventional and well known. For example, the elastomeric-substrate 22 may be produced by employing an extrusion and/or meltblowing method, and the polypropylene-based adhesive 24 or other surface modifying agent can be produced and applied by employing another, separately configured meltblowing operation. During the application of the surface modifying agent, the elastomeric-substrate can be transported or carried on a temporary support layer to help maintain a desired, substantially unstretched condition of the elastomeric-substrate 22.

In the elastomeric composite web 20 of the present invention, the elastomeric-substrate 22 can include an elastic polymer film or elastic nonwoven fabric. Additionally, a surface modifying agent can be applied to the elastomeric-substrate, and the surface modifying agent can desirably include an elastomeric adhesive, such as a polypropylene-based elastomeric adhesive. The elastomeric-substrate layer can desirably be a polymer film, or an array of continuous fine-fibers, such as a layer of meltblown elastic fibers. If a polymer film is employed, the film may be apertured.

In the elastomeric-substrate 22, the elastomeric film or fibers may be made from thermoplastic materials such as block copolymers having the general formula A-B-A′ where A and A′ are each a thermoplastic polymer endblock which contains a styrenic moiety such as a poly (vinyl arene) and where B is an elastomeric polymer midblock such as a conjugated diene or a lower alkene polymer.

Specific examples of useful styrenic block copolymers include hydrogenated polyisoprene polymers such as styrene-ethylenepropylene-styrene (SEPS), styrene-ethylenepropylene-styrene-ethylenepropylene (SEPSEP), hydrogenated polybutadiene polymers such as styrene-ethylenebutylene-styrene (SEBS), styrene-ethylenebutylene-styrene-ethylenebutylene (SEBSEB), styrene-butadiene-styrene (SBS), styrene-isoprene-styrene (SIS), and hydrogenated poly-isoprene/butadiene polymer such as styrene-ethylene-ethylenepropylene-styrene (SEEPS). Polymer block configurations such as diblock, triblock, multiblock, star and radial are also contemplated in this invention. In some instances, higher molecular weight block copolymers may be desirable. Block copolymers are available from Kraton Polymers U.S. LLC of Houston, Tex., U.S.A. under the designations KRATON G or KRATON D polymers, for example G1652, G1657, G1730, D1114, D1155, D1102; and from Septon Company of America, Pasadena, Tex., U.S.A., under the designations SEPTON 2004, SEPTON 4030, and SEPTON 4033. Other potential suppliers of suitable polymers include Dexco Polymers of Houston, Tex., U.S.A., and Dynasol of Madrid, Spain. Blends of such elastomeric resin materials are also contemplated as the primary component of the elastomeric-substrate layer 22. Additionally, other desirable block copolymers are disclosed in U.S. Patent Application Publication 2003/0232928A1, the entirety which is incorporated herein by reference.

Such base resins may be further combined with tackifiers and/or processing aids in compounds. Exemplary compounds include but are not limited to KRATON G 2760, and KRATON G 2755. Processing aids that may be added to the elastomeric polymer described above include a polyolefin to improve the processability of the composition. The polyolefin must be one which, when so blended and subjected to an appropriate combination of elevated pressure and elevated temperature conditions, is extrudable, in blended form, with the elastomeric base polymer. Useful blending polyolefin materials include, for example, polyethylene, polypropylene and polybutene, including ethylene copolymers, propylene copolymers and butene copolymers. A particularly useful polyethylene may be obtained from Eastman Chemical under the designation EPOLENE C-10. Two or more of the polyolefins may also be utilized. Extrudable blends of elastomeric polymers and polyolefins are disclosed in, for example, U.S. Pat. No. 4,663,220.

The elastomeric fiber or film may have some tackiness/ adhesiveness to enhance autogenous bonding. For example, the elastomeric polymer itself may be tacky when formed into films, and/or fibers. Alternatively, a compatible tackifying resin may be added to the extrudable elastomeric compositions described above to provide tackified elastomeric fibers that can autogenously bond. In regards to the tackifying resins and tackified extrudable elastomeric compositions, suitable resins and compositions may include those disclosed in U.S. Pat. No. 4,787,699, which is incorporated herein by reference in its entirety in a manner that is consistent herewith.

Any tackifier resin can be used which is compatible with the elastomeric polymer and can withstand the high processing (e.g. extrusion) temperatures If the elastomeric polymer (e.g. A-B-A elastomeric block copolymer) is blended with processing aids such as, for example, polyolefins or extending oils, the tackifier resin should also be compatible with those processing aids. Generally, hydrogenated hydrocarbon resins are preferred tackifying resins, because of their better temperature stability. REGALREZ series tackifiers are examples of such hydrogenated hydrocarbon resins. REGALREZ hydrocarbon resins are available from Eastman Chemical. Of course, the present invention is not limited to use of such tackifying resins, and other tackifying resins which are compatible with the other components of the composition and can withstand the high processing temperatures, can also be used. Other tackifiers are available from ExxonMobil under the ESCOREZ designation.

Other exemplary elastomeric materials which may be used include polyurethane elastomeric materials such as, for example, those available under the trademark ESTANE from Noveon, Inc. of Cleveland, Ohio, U.S.A., polyamide elastomeric materials such as, for example, those available under the trademark PEBAX (polyether amide) from Ato Fina Company, and polyester elastomeric materials such as, for example, those available under the trade designation HYTREL from E.I. DuPont De Nemours & Company.

Useful elastomeric polymers also include, for example, elastic polymers and copolymers of ethylene and at least one vinyl monomer such as, for example, vinyl acetates, unsaturated aliphatic monocarboxylic acids, and esters of such monocarboxylic acids. The elastic copolymers and formation of elastomeric meltblown fibers from those elastic copolymers are disclosed in, for example, U.S. Pat. No. 4,803,117, which is incorporated by reference herein in its entirety.

Additional materials, which may be utilized in the elastomeric-substrate 22 to provide some extensibility with limited recovery, can include single site catalyzed polyolefinic materials, such as metallocene catalyzed polyolefins and constrained geometry polyolefins, such as available from Dow under the designation AFFINITY and from ExxonMobil, under the designation EXACT. Desirably, such materials have densities of less than 0.89 g/cc.

Where the elastomeric-substrate 22 is made from an extruded material in an on-line process, the blend used to form the elastomeric film or elastomeric fibers can include, for example, from about 40 wt % to about 90 wt % of an elastomeric polymer base resin, from about 0 to about 40 wt % of a polyolefin processing aid, and from about 0 wt % to about 50 wt % of a resin tackifier. These amounts can be varied depending on the specific properties desired and the polymers utilized. For an alternative configuration, such blend can include between about 60-80 wt % base resin, between about 5-30 wt % of a processing aid, and between about 10-30 wt % tackifier. In a further alternative configuration, the blend can include a tackifier in an amount of between about 10-20 wt %.

The elastomeric-substrate 22 can be configured to include a nonwoven elastomeric fabric, an elastomeric polymer film, or any desired combination thereof. Any operative nonwoven fabric or polymer film may be employed. In a desired configuration, the elastomeric-substrate 22 can include a nonwoven fabric of meltblown elastomeric fibers. In a particular aspect, the selected fabric of elastomeric fibers can have a fabric basis weight which is at least a minimum of about 10 g/m². The fabric basis weight can alternatively be at least about 20 g/m², and can optionally be at least about 25 g/m2 to provide desired benefits. In other aspects, the fabric basis weight can be up to a maximum of about 400 g/m², or more. The fabric basis weight can alternatively be up to about 100 g/m², and can optionally be up to about 40 g/m² to provide desired effectiveness.

Optionally, the elastomeric-substrate 22 can include an elastomeric film. In a particular feature, the film basis weight can be at least a minimum of about 5 g/m². The film basis weight can alternatively be at least about 10 g/m², and can optionally be at least about 20 or 25 g/m² to provide desired benefits. In other aspects, the film basis weight can be up to a maximum of about 150 g/m², or more. The film basis weight can alternatively be up to about 80 g/m², and can optionally be up to about 40 g/m² to provide desired effectiveness.

If the fabric basis weight or film basis weight is too small, too large, or is otherwise outside the desired values, the fabric may be inadequate for incorporation into desired personal care products.

In particular aspects, the elastomeric-substrate 22 can be a nonwoven fabric, and the fabric can include fibers having fiber sizes which are no more than a maximum of about 3 denier (grams per 9000 meters) or about 33.3 decitex (grams per 10,000 m). The elastomeric fabric can alternatively, have fiber sizes which are no more than a maximum of about 2 denier (about 22.2 decitex), and can optionally have deniers which are no more than a maximum of about 1.5 denier (about 1.67decitex) to provide desired benefits.

With regard to a contiguous region of the elastomeric-substrate 22 having a cross-directional, contiguous width of at least a minimum of about 5 mm and a machine-direction contiguous length of at least a minimum of about 50 mm, the elastomeric-substrate has been substantially devoid or otherwise substantially free of elastomeric, continuous filament strands, particularly at the time when the layer of elastomeric polypropylene-based adhesive 24 material or other surface modifying agent was adhered or otherwise applied to the elastomeric-substrate. Accordingly, the elastomeric-substrate has been substantially free of substantially continuous, elastomeric strands along a significant distance of contiguous cross-directional width and/or machine-directional length when the layer of surface modifying agent was applied to the elastomeric-substrate. The substantially strand-free, contiguous region of the elastomeric-substrate can alternatively have a cross-directional, contiguous width of at least a minimum of about 10 mm or 15 mm, and can optionally have a cross-directional, contiguous width of at least a minimum of about 20 mm or 25 mm to provide improved utility. Additionally, the substantially strand-free, contiguous region of the elastomeric-substrate can have a cross-directional, contiguous width of up to about 50 mm or 100 mm or more to provide desired benefits.

In a desired aspect, the-elastomeric-substrate 22 has been substantially free of continuous elastomeric strands that are longer than about 5 cm. In another aspect, the elastomeric-substrate 22 has been substantially devoid of elastomeric, continuous filament strands that have an individual-strand, overall strand-denier which is greater than about 20 denier (about 22.2 decitex), particularly at the time when the layer of elastomeric polypropylene-based adhesive 24 material or other surface modifying agent was adhered or otherwise applied to the elastomeric-substrate. The elastomeric-substrate has alternatively been substantially devoid of individual elastomeric strands that have an overall strand-denier which is greater than about 25 denier (about 27.8 decitex), and has optionally been substantially devoid of individual elastomeric strands that have an overall strand-denier which is greater than about 30 denier (about 33.3 decitex).

In a further aspect, at the time when the layer of elastomeric polypropylene-based adhesive 24 material or other surface modifying agent was adhered, bonded or otherwise applied to the elastomeric-substrate, the elastomeric-substrate 22 has been substantially free of individual elastomeric strands having a strand diameter or strand width which is greater than about 0.05 mm. The elastomeric-substrate has alternatively been substantially free of individual elastomeric strands having a strand diameter or strand width which is greater than about 0.07 mm, and has optionally been substantially free of individual elastomeric strands having a strand diameter or strand width which is greater than about 0.1 mm.

In still another aspect, the elastomeric-substrate 22 has been substantially free of elastomeric, continuous filament strands that are substantially parallel with each other. In a desired feature, the elastomeric-substrate 22 has been substantially free of the elastomeric strands at the time when the layer of elastomeric polypropylene-based adhesive 24 or other surface modifying agent was adhered or otherwise applied to the elastomeric-substrate.

With regard to a contiguous region of the elastomeric composite 20 having a cross-directional, contiguous width of at least a minimum of about 5 mm and a machine-direction contiguous length of at least a minimum of about 50 mm, the elastomeric composite can be substantially devoid or otherwise substantially free of the elastomeric, continuous strands. The substantially strand-free, contiguous region of the elastomeric composite can alternatively have a cross-directional, contiguous width of at least a minimum of about 10 mm, and can optionally have a cross-directional, contiguous width of at least a minimum of about 20 mm to provide improved utility. Additionally, the substantially strand-free, contiguous region of the elastomeric composite can have a cross-directional, contiguous width of up to about 50 mm or 100 mm or more to provide desired benefits. In a particular aspect, the elastomeric composite 20 can be substantially free of continuous, elastomeric strands that are longer than 5 cm. In other aspects, the elastomeric composite 20 can be substantially devoid of elastomeric, continuous strands having the various arrangements that are described herein with respect to the elastomeric-substrate 22.

In a desired aspect, the elastomeric-substrate 22 has been substantially free of the elastomeric strands at the time when the layer of elastomeric polypropylene-based adhesive material 24 or other surface modifying agent was adhered or otherwise applied to the elastomeric-substrate. In another aspect, the elastomeric composite 20 can continue to be substantially devoid of the elastomeric strands at the time the elastomeric composite is operatively accumulated for bulk storage and/or bulk transfer.

In particular aspects, the surface modifying agent can, for example, include polyolefins, metallocene polyethylene, metallocene polypropylene, polyacrylate copolymers, ethylene-vinyl acetate (EVA) copolymers, ethylene-methylacrylate (EMA) copolymers, ethylene-butylacrylate (EBA) copolymers, elastomeric polymers with or without tackifiers, and the like, as well as combinations thereof. The employed materials may, for example, include SIS, SBS, SEBS and SEPS block copolymers, as well as combinations thereof. In a desired aspect, the selected polymers can have a high, melt flow rate of 20 or more, and the melt flow rate can be determined by employing ASTM D 1230, at 200° C. and 5 kg.

The surface modifying agent can, for example, include a hot melt adhesive, a pure polymer, or a polymer blend; and can, for example, be provided by a processing which employs hot melt equipment and/or extrusion equipment. In desired configurations, the surface modifying agent can include a polypropylene-based adhesive. In another aspect, the elastic laminate or other elastomeric composite web 20 can include a surface modifying agent which has been deposited on the elastomeric-substrate 22 by employing a meltblowing operation.

The employed surface modifying agent treatment may include a relatively low basis weight, meltblown material applied to the top of the elastomeric-substrate 22. Desirably, the low basis weight meltblown is not readily visible to the human eye. Depending on what attributes are desired, the meltblown application can be varied within desired ranges. For instance, if a more elastic composite 20 is desired, the meltblown application could be on the lower end of the range. Such meltblown material may be produced by one or more meltblown banks depending on the basis weight desired. Alternatively, the meltblown may be of an elastic material without a tackifier. Desirably, the employed surface modifying agent can be a non-tacky polypropylene meltblown material which is exemplified by VALTEC HH442H, and BASELL PF-015 material, which are available from Basell NA, Inc., a business having offices located in Elkton, Md., U.S.A. The VALTEC HH442H, for example, can have a MFR (Melt Flow Rate) of about 1100. The MFR can be determined by employing ASTM D1238, at 230° C. and per 2.16 kg.

The surface modifying agent (SMA) can be distributed in a light coating in the various arrangements described herein, and can, for example, be configured to provide a light surface covering on a tacky substrate layer. The SMA can further be configured to substantially avoid excessively reducing the ability of the laminate to retract. For example, the surface modifying agent in one configuration can be less than about 14% of the basis weight of the-elastomeric substrate layer, as determined with respect to the weight of the substrate layer alone. Desirably, the surface modifying agent in an alternative configuration can be less than 7% of the basis weight of the elastic layer. In still a further alternative configuration, the surface modifying agent can be less than 4% of the basis weight of the elastic layer. The surface modifying agent can desirably be tightly adhered to the surfaces of the elastic layer such that there is no significant separation from the elastomeric-substrate 22 when elastomeric composite web 20 is stretched and allowed to retract.

In a particular feature of the invention, the composition of the material employed to form the elastomeric-substrate 22 can be substantially free and devoid of the selected, surface modifying agent. More particularly, the film or fiber material employed to form the elastomeric-substrate 22 can be substantially-free of the separately provided, polypropylene-based adhesive material 24. Accordingly, the polypropylene-based adhesive material 24 or other surface modifying agent is a component that has been provided separate from the material of the elastomeric-substrate, and has subsequently been assembled or otherwise combined with the elastomeric-substrate after the formation of the elastomeric-substrate in a significantly non-simultaneous operation.

With respect to the elastomeric-substrate 22, the employed polypropylene-based adhesive layer 24 or other selected surface modifying agent can be distributed and arranged in any operative pattern or array, and the pattern or array can be discontinuous or substantially continuous.

The elastomeric polypropylene-based adhesive 24 can be adhered directly to the elastomeric-substrate by employing any operative process. Suitable techniques can, for example, include a spraying process, a meltblowing process, a melt swirl process, a spunbond process, an electro-spinning process, a lamination process, a coating process, a dip coating, a cast coating, a slot coating or the like, as well as combinations thereof.

In desired arrangements, the layer of elastomeric polypropylene-based adhesive 24 can be configured in a distributed, reticulated array. Particular arrangements can include a reticulated array of melt-sprayed adhesive that has been operatively distributed and connected onto the elastomeric-substrate 22. In further arrangements, the employed-array of adhesive can include a reticulated array of melt-sprayed adhesive particles or fibers.

The employed treatment of the surface modifying agent (e.g. polypropylene based adhesive material 24) can, for example, include a dusting of an operative amount of meltblown material. In particular aspects, the meltblown application amount can be at least a minimum of about 0.5 g/m². The meltblown application amount can alternatively be at least about 1 g/m², and can optionally be at least about 1.5 g/m² to provide desired benefits. In other aspects, the meltblown application amount can be up to a maximum of about 10 g/m², or more. The meltblown application amount can alternatively be up to about 8 g/m², and can optionally be up to about 6 g/m² to provide desired effectiveness. In yet another alternative configuration, the meltblown application amount can be up to about 4 g/m².

In desired arrangements, the elastomeric composite web 20 can have a configuration in which the selected surface modifying agent includes a layer of elastomeric polypropylene-based adhesive 24 that has been applied at an adhesive basis weight within the described ranges and values.

In particular aspects, the elastomeric polypropylene-based adhesive 24 can be a hotmelt adhesive, and the hotmelt adhesive had a melt-temperature that was within the range of about 160-200° C., particularly during the application of the polypropylene-based adhesive onto the elastomeric-substrate 22. In another aspect, the elastomeric polypropylene-based adhesive 24, in its molten state, had a melt-viscosity of not more than a maximum of about 6000 centipoise (cP) at a temperature of 175° C., particularly during the application of the polypropylene-based adhesive onto the elastomeric-substrate.

In other aspects, the elastomeric polypropylene-based adhesive can include a material produced by operatively admixing:
up to about 60 wt % of an atactic-polypropylene, or an amorphous poly-alpha-olefin (APAO) which contains an operative amount of polypropylene;
5 to about 25 wt % of a high melt flow crystalline polypropylene;
0 to about 20 wt % of a high melt flow SEPS and/or SIS, metallocene polyethylene/propylene thermoplastic elastomer, and/or ethylene-vinyl acetate;
0 to about 40 wt % of tackifiers, or
   other hydrocarbon resins from petroleum distillates,
   rosins and/or rosin esters,
   polyterpenes derived from wood or synthetic chemicals;
0 to about 5 wt % of additives; and
0 to about 20 wt % of viscosity modifiers;
with the proviso that the employed ingredients total 100 wt %.

The employed atactic-polypropylene, or poly-alpha-olefin (APAO) can, for example be provided by EASTMAN P1010 or P1023 materials,-which are available from the Eastman Chemical Company, a business having offices located in Kingsport, Tenn., U.S.A.; or by a H2115 material which is available from Huntsman Polymers of Houston, Tex., U.S.A.

The incorporated high melt flow crystalline polypropylene can, for example, include SUNOCO CP15000P or EXXON PP 3746G materials. The SUNOCO material is available from SUNOCO, a business having offices located in Pittsburg, Pa., U.S.A., and the EXXON material is available from ExxonMobil Chemical Company, a business having offices located in Houston, Tex., U.S.A. In a particular aspect, the high melt flow polypropylene can, for example have a melt flow index (MF) which is within the range of about 500-2000.

The employed high melt flow SEPS and/or SIS, metallocene polyethylene/propylene thermoplastic elastomers, and/or ethylene-vinyl acetate materials can, for example, include SEPTON, KRATON, EXXON DEXCO SIS polymers, ESCORENE ULTRA or DuPont Dow—ENGAGE 8400 series materials, and ELVAX 240 materials. The SEPTON material is available from Kurary LTD., a business having offices located in Japan. The KRATON material is available from Kraton Polymers Inc., a business having offices located in Houston, Tex., U.S.A. DEXCO VECTOR material, such as DPX-584 material is available from DEXCO Polymers Inc., a business having offices located in Houston, Tex., U.S.A. The ESCORENE material is available from the ExxonMobil Chemical Company, a business having offices located in Houston, Tex., U.S.A. The DuPont Dow material is available from E.I. DuPont de Nemours & Company, Inc., a business having offices located in Wilmington, Del., U.S.A. The ELVAX material is also available from DuPont.

The employed tackifier materials can, for example, include ESCORZE series materials from ExxonMobil Chemical, or EASTOTAC H-100R from Eastman Chemical. The incorporated additives can, for example, include an antioxidant and/or a colorant/filler. Such materials can, for example include an IRGANOX 1010 antioxidant which is available from Ciba Specialty, a business having offices located in Greensboro, N.C., U.S.A. The colorant/filler can, for example, include TiO₂ or CaCO₃ materials. The incorporated viscosity modifiers can, for example, include mineral oil.

It should be readily appreciated that the admixed amounts of the components of the surface modifying agent (e.g. elastomeric adhesive) should total 100%, and the percentage values are determined with respect to the final overall weight of the desired admixture. Suitable procedures and equipment for mixing the component materials of the surface modifying agent can include conventional admixing and/or extrusion techniques and systems.

The elastomeric composite web 20 of the invention can include a configuration in which the composite web 20 has been accumulated into a bulk storage configuration prior to attaching the elastomeric-substrate 22 to any separately provided, substantially non-elastomeric, supplemental-substrate. For example, the composite web 20 can be suitably accumulated for storage by being rolled, festooned, folded, level wound, spooled or the like, as well as combinations thereof. Desirably, the elastomeric composite web 20 can be efficiently rolled over onto itself for convenient storage, if the web material is not to be used immediately.

Desirably, the elastomeric composite web material 20 can contract or recover at least 50 percent of the stretch-length in a particular direction, such as in either of its machine-direction 28 (MD) or cross-machine direction 30 (CD). The amount of recovery can also be up to about 80 percent of the stretch-length in a particular direction, such as in either its machine-direction or its cross-machine direction. Even more desirably, such elastomeric material can recover by an amount that is greater than 80 percent of the stretch-length in a particular direction, such as in either the machine-direction or the cross-machine direction. In another aspect, such elastomeric material can be stretchable and recoverable in both of its MD and CD directions.

In a particular aspect, the elastomeric composite web 20 can be at least biaxially stretchable along a pair of orthogonal directions (e.g. directions 28, 30). In a particular aspect, in at least each of the biaxial stretch directions, the composite web 20 can provide an initial elastomeric stretch which is at least about 50% of its relaxed base length (L₀), and can provide a permanent set value which is less than about 10% or less than about 15% after being subjected to a predetermined amount of stretch.

The percentage value of the initial amount of elastomeric stretch can be determined by the following calculation: 100*(L₁−L₀)/L₀;
wherein: L₁=stretched length of the elastomeric composite web;
L₀=relaxed base length of the elastomeric composite web.

The percentage value of the amount of permanent set can be determined by the following calculation: 100*(Lₛₑₜ−L₀)/L₀;
wherein: L₀=relaxed base length of the elastomeric composite web;
Lₛₑₜ=re-shortened length of the elastomeric composite web upon its contraction after being stretched and allowed to relax.

The amounts of elastomeric stretch and permanent set can be determined by employing the Stress-Strain Cycle test method disclosed herein.

In another aspect, the elastomeric composite web 20 can provide an initial stretch value which is at least about 50% of its relaxed length, in -each of its biaxial stretch directions. Additionally, the initial stretch value in each of its biaxial stretch directions can be provided substantially without rupturing the layer of elastomeric polypropylene-based adhesive 24.

The elastomeric composite web 20 can also exhibit a permanent set value of less than 5%, as determined upon relaxation after an initial stretching of the elastomeric composite web to 100% elongation. In a further aspect, the composite web 20 can exhibit a permanent set value of less than 10%. The composite web can alternatively exhibit a permanent set value of less than 15%, and can optionally exhibit a permanent set value of less than 20% to provide desired utility or benefits.

The elastomeric composite web 20 can better maintain its elastic properties, and the stretchability of the composite web in its machine-direction and cross-direction can be maintained without excessive degradation. Additionally, the permanent-set and hysteresis properties of the composite web are not excessively degraded. In a further feature, the composite web can provide an improved tactile feel, particularly on the surface sides of the composite web that have been operatively coated with the selected surface modifying agent. The tactile feel can be more clothlike and more attractive to consumers.

The elastomeric composite web 20, on its major facing-side that does not have the separately provided layer of surface modifying agent (e.g. the “uncoated” major facing-side that does not have the elastomeric polypropylene-based adhesive 24), can have a first coefficient of friction (COF1). Additionally, the elastomeric-substrate, on its facing-side that does have the separately provided layer of the selected surface modifying agent (e.g. the “coated” major facing-side that does have the elastomeric polypropylene-based adhesive 24) can have a second coefficient of friction (COF2). In a particular feature, the percentage of difference in coefficient of friction can be at least minimum of about 10%. The percent difference can alternatively be at least about 15%, and can optionally be at least about 20% to provide desired benefits. In another feature, the percent difference can be up 30% or more. The percent difference in coefficient of friction can be determined by employing the following calculation:
% difference=100*(COF1−COF2)*(COF1).

With reference to FIG. 1, the representatively shown process and apparatus 40 deposits elastomer fibers 42 directly onto a conveyor system to form an elastomeric-substrate layer 22. The conveyor system can include a forming surface system 44 (e.g., a foraminous, forming-wire belt) moving about a cooperating system of rollers 46. A meltblowing bank 48 can operatively form the elastomer fibers 42, and a vacuum system (not shown) can generate an operative vacuum force to help hold the deposited fibers 42 against the foraminous forming surface 44. The elastomer fibers 42, can include a suitable elastomeric material, such as the materials previously described, and the elastomer material can be extruded and fiberized from the meltblowing bank 48, such that the meltblown fibers 42 are operatively placed on top of the forming surface 44. It should be readily appreciated that a plurality of two or more meltblowing banks may be employed to form the elastomeric-substrate layer 22 into desired basis weights.

One or more additional meltblown banks 50 can be positioned downstream and adjacent the first meltblown bank, and can extrude meltblown fibers 32 to form an operative layer of a polypropylene-based adhesive 24 or other surface modifying agent onto the top, major facing-side 26 of the elastomeric-substrate layer 22, and thereby form the desired elastomeric composite web 20. The composite web 20 may optionally be compacted by an operative compacting system, such as provided by the representatively shown pair of counter-rotating compression rolls 52. The surface modifying agent may be a polyolefin or elastic polyolefin polymer as previously described. Additionally, amorphous polyalpha olefins (APAO) that are non-tacky may be utilized. Additionally, elastomeric materials without tackifiers may also be utilized. In a desired configuration, a polypropylene-based adhesive, such as those previously described, may be meltblown onto the previous formed substrate layer 22 of elastomeric material. To melt the materials of the selected surface modifying agent, a grid melter (or other conventional system of hot melt equipment) may be employed, and the selected material may be supplied to the melting operation in any operative form, such as in drums, pellets, blocks or the like.

In a particular configuration, all rolls that come into contact with the untreated side of the composite web 20 (e.g. the side of the web that is opposite the facing-side 26) can desirably include a non-stick surface, such as a coating of PTFE (polytetrafluoroethylene), or silicone rubber, release coating. Such rolls may further be coated with IMPREGLON coatings which are available from Southwest Impreglon, of Houston, Tex., U.S.A.; or may be coated with Stowe-Woodward SILFEX silicone rubber coatings having a hardness of 60 Shore A, which are available from Stowe-Woodward, Inc., a business having offices located in Neenah, Wis., U.S.A.

In an optional arrangement of the method and apparatus 40, the application of the surface modifying agent may be conducted in an off-line operation. The formation of the elastomeric-substrate 22 may be conducted on a first production line, such as a first meltblowing operation line, and the application of the surface modifying agent may be conducted on a separate operation line. The separate off-line operation may, for example be desired when there is a significantly large difference between the production speed during the formation of the elastomeric-substrate 22, and the production speed during the formation of the layer of polypropylene-based adhesive 24 or other surface modifying agent. In the off-line operation, it may be desirable to preliminarily lay the elastomeric-substrate onto a temporary support layer to help maintain a desired, substantially unstretched condition of the elastomeric-substrate 22 during the application of the surface modifying agent. The use of the temporary support layer may be particularly desirable when the elastomeric-substrate 22 includes a fabric comprising meltblown elastomer fibers. The temporary support layer may, for example, be provided by an operative layer of tissue, nonwoven fabric, woven fabric or the like. The support layer is substantially non-stretchable when subjected to a tensile force of 2.5 N per inch (2.54 cm). In a desired feature, the support layer can exhibit a stretch of not more than 5% when subjected to the tensile force of 3.3 N per inch (2.54 cm).

The laminate structure of the elastomeric composite web 20 can be seen in FIG. 2 which illustrates a cross sectional stylistic view of the composite web made in accordance with the present invention. As representatively shown, the web has a machine-direction 28 and a cross-direction 30, and includes an elastomeric-substrate 22 and a layer of the selected surface modifying agent (e.g. the layer of polypropylene-based adhesive 24). The surface modifying agent can be adhered or otherwise operatively bonded to the major facing-side of the elastomeric-substrate 22. The thicknesses of the various layers are not to scale, and are exaggerated to illustrate their existence. It should be emphasized, that particularly with respect to the surface modifying agent layer, the layer merely is a close topical application onto the underlying elastomeric-substrate (meltblown layer of elastomer fibers). The surface modifying agent layer does not form visually ( with the human eye) distinct gathers between bond points to the elastic meltblown layer.

The elastomeric composite web material 20 may be useful in providing elastic waist portions, elastic leg cuff/gasketing portions, stretchable ear, stretchable side panel, or stretchable outer cover portions. While not intending to be limited to any particular use or product configuration, FIG. 3 is presented to illustrate the various components of a representative personal care product, such as a diaper, that may take advantage of such elastic composite web materials. Other examples of personal care products that may incorporate such elastic composite materials are training pants (such as in side panel materials), adult incontinence products and feminine care products. By way of illustration only, training pants suitable for use with the present invention and various materials and methods for constructing the training pants are disclosed in PCT Patent Application WO 00/37009 published Jun. 29, 2000 by A. Fletcher et al; U.S. Pat. No. 4,940,464 issued Jul. 10, 1990 to Van Gompel et al.; U.S. Pat. No. 5,766,389 issued Jun. 16, 1998 to Brandon et al.; and in U.S. Pat. No. 6,645,190 issued Nov. 11, 2003 to Olson et al., each of which is incorporated herein by reference in its entirety.

With reference to FIG. 3, the representatively shown disposable diaper 250 generally defines a front waist section 255, a rear waist section 260, and an intermediate section 265 which interconnects the front and rear waist sections. The front and rear waist sections 255 and 260 include the general portions of the diaper which are constructed to extend substantially over the wearer's front and rear abdominal regions, respectively, during use. The intermediate section 265 of the diaper includes the general portion of the diaper that is constructed to extend through the wearer's crotch region between the legs. Thus, the intermediate section 265 is an area where repeated liquid surges typically occur in the diaper.

The diaper 250 can include, without limitation, an outer cover, or backsheet 270, a liquid permeable bodyside liner, or topsheet, 275 positioned in facing relation with the backsheet 270, and an absorbent core body, or liquid retention structure, 280, such as an absorbent pad, which can be located and held between the backsheet 270 and the topsheet 275. The backsheet 270 defines a length, or longitudinal direction 286, and a width, or lateral direction 285 which, in the illustrated configuration, coincide with the length and width of the diaper 250. The liquid retention structure 280 generally has a length and width that are less than the length and width of the backsheet 270, respectively. Thus, marginal portions of the diaper 250, such as marginal sections of the backsheet 270 may extend past the terminal edges of the liquid retention structure 280. In the illustrated configurations, for example, the backsheet 270 extends outwardly beyond the terminal marginal edges of the liquid retention structure 280 to form side margins and end margins of the diaper 250. The topsheet 275 is generally coextensive with the backsheet 270, but may-optionally cover an area which is larger or smaller than the area of the backsheet 270, as desired.

To provide improved fit and to help reduce leakage of body exudates from the diaper 250, the diaper side margins and end margins may be elasticized with suitable elastic members, as further explained below. For example, as representatively illustrated, the diaper 250 may include leg elastics 290 which are constructed to operably tension the side margins of the diaper 250 to provide elasticized leg bands which can closely fit around the legs of the wearer to reduce leakage and provide improved comfort and appearance. Waist elastics 295 can be employed to elasticize the end margins of the diaper 250 to provide elasticized waistbands. The waist elastics 295 can be configured to provide a resilient, comfortably close fit around the waist of the wearer.

The elastomeric composite webs 20 of the present invention can be suitable for use as the leg elastics 290 and waist elastics 295. Exemplary materials are composite webs which either comprise or are adhered to the backsheet, such that elastic constrictive forces are imparted to the backsheet 270.

As is known, fastening means, such as hook and loop fasteners, may be employed to secure the diaper 250 on a wearer. Alternatively, other fastening means, such as buttons, pins, snaps, adhesive tape fasteners, cohesives, fabric-and-loop fasteners, or the like, may be employed. As shown in the illustrated configuration, the diaper 250 may include a pair of side panels 300 (or ears) to which the fasteners 302, indicated as the hook portion of a hook and loop fastener, are attached. Generally, the side panels 300 can be attached to the side edges of the diaper in one of the waist sections 255, 260 and can extend laterally outward therefrom. The side panels 300 may be elasticized or otherwise rendered elastomeric by use of the elastomeric composite webs made in accordance with the present invention. Examples of absorbent articles that include elasticized side panels and selectively configured fastener tabs are described in PCT Patent Application No. WO 95/16425 to Roessler; U.S. Pat. No. 5,399,219 to Roessler et al.; U.S. Pat. No. 5,540,796 to Fries; and U.S. Pat. No. 5,595,618 to Fries; each of which is hereby incorporated by reference in its entirety.

The diaper 250 may also include a surge management layer 305, located between the topsheet 275 and the liquid retention structure 280, to rapidly accept fluid exudates and distribute the fluid exudates to the liquid retention structure 280 within the diaper 250. Examples of suitable surge management layers 305 are described in U.S. Pat. No. 5,486,166 to Bishop and U.S. Pat. No. 5,490,846 to Ellis. The diaper 250 may further include a ventilation layer (not illustrated), also called a spacer, or spacer layer, located between the liquid retention structure 280 and the backsheet 270 to help insulate the backsheet 270 from the liquid retention structure 280 to reduce the dampness of the garment at the exterior surface of a breathable outer cover, or backsheet, 270.

As representatively illustrated, the disposable diaper 250 may also include a pair of containment flaps 278 which are configured to provide a barrier to the lateral flow of body exudates. The containment flaps 278 may be located along the laterally opposed side edges of the diaper adjacent the side edges of the liquid retention structure 280. Each containment flap 278 typically defines an unattached edge which is configured to maintain an upright, perpendicular configuration in at least the intermediate section 265 of the diaper 250 to form a seal against the wearer's body. The containment flaps 278 may extend longitudinally along the entire length of the liquid retention structure 280 or may only extend partially along the length of the liquid retention structure. When the containment flaps 278 are shorter in length than the liquid retention structure 280, the containment flaps 278 can be selectively positioned anywhere along the side edges of the diaper 250 in the intermediate section 265. Such containment flaps 278 are generally well known to those skilled in the art. For example, suitable constructions and arrangements for containment flaps 278 are described in U.S. Pat. No. 4,704,116 to K. Enloe. The containment flaps may be operatively elasticized by incorporating the elastomeric composite webs 20 of the present invention.

The diaper 250 may be of various operative shapes. For example, the diaper may have an overall rectangular shape, T-shape or an approximately hour-glass shape. In the shown configuration, the diaper 250 has a generally I-shape. Other suitable components which may be incorporated on absorbent articles of the present invention may include waist flaps and the like which are generally known to those skilled in the art. Examples of diaper configurations, which may incorporate the present invention and which may include other diaper components, are described in U.S. Pat. No. 4,798,603 to Meyer et al.; U.S. Pat. No. 5,176,668 to Bernardin; U.S. Pat. No. 5,176,672 to Bruemmer et al.; U.S. Pat. No. 5,192,606 to Proxmire et al. and U.S. Pat. No. 5,509,915 to Hanson et al.; each of which is hereby incorporated herein by reference in its entirety.

The various components of the diaper 250 can be assembled together employing various types of suitable attachment means, such as adhesive bonding, ultrasonic bonding, thermal point bonding or combinations thereof. In the shown configuration, for example, the topsheet 275 and backsheet 270 may be assembled to each other and to the liquid retention structure 280 with lines of adhesive, such as a hot melt, pressure-sensitive adhesive. Similarly, other diaper components, such as the elastic members 290 and 295, fastening members 302, and surge layer 305 may be assembled into the article by employing the above-identified attachment mechanisms.

It should be appreciated that the elastomeric composite web 20 of the invention may likewise be employed in other personal care products, protective outerwear, protective coverings, and the like. Further, such composite web materials can be used in bandage materials for both human and animal bandaging products. The use of such composite web materials can, for example, provide acceptable elastic performance at a lower manufacturing cost.

The following examples are given to provide a more detailed understanding of the invention. The particular materials, dimensions, amounts and other parameters are exemplary, and are not intended to specifically limit the scope of the invention.

### EXAMPLE 1

Elastomeric composite webs (20) were made, employing a meltblowing process to form the primary elastomeric-substrate (22). The composite web was suitable for making a cloth-like, meltblown elastic topsheet, and the topsheet was suitable for an inner elastic liner layer of a personal care article having good fit and conformance. The web included meltblown KRATON G6631 blended with metallocene polyethylene to enhance its likeness to ordinary cloth.

A meltblown nonwoven elastic substrate web (22) was made from styrene-ethylene-butylene-styrene (SEBS) block copolymer and ethylene octene copolymer by employing a dry blending operation and a meltblown extrusion process. A single screw extruder was used to process all polymers. KRATON G6631 polymer (SEBS with tackifiers) was blended with EXACT 0230 material, in a respective weight ratio of 80 to 20. From the meltblowing bank, the meltblown material was deposited onto a foraminous forming surface provided by a forming wire (belt) moving at a speed of about 8.3 fpm (ft/min) (about 2.53 m/min). The extruder for the meltblown system had melt, hose and die temperatures which were between about 475-540° F. (about 246-282° C.), and an air temperature of about 570° F. (about 299° C.). The air was supplied at a pressure of 32 psi (22.1 KPa) at both sides of the meltblowing head. The extruder operated with a single screw speed of 6 rpm (revolutions per minute), and the height of the meltblowing die above the forming wire was about 15 inches (about 38 cm). No added bonding was used to increase the integrity of the meltblown, elastic nonwoven web. The produced elastic nonwoven web had a final measured basis weight of about 1.5 osy (50.87 g/m²), and was wound onto a core under minimal tension.

In a separate process, the elastic meltblown web (22) was coated using a meltblown spray of adhesive from a grid melter. The melt, hose and die temperatures were about 340-360° F. (171.1-182.2° C.), and the meltblown spray of the coating material was applied onto the elastic web without employing a pressure nip. A nonwoven spunbond, conveyor-sheet was employed to support and avoid excessively stretching the meltblown elastic web while moving the elastic web through the coating process at about 50 ft/min (about 15.2 m/min). The composite, coated web (20) was then wound onto a core at minimal tension. The coating material included a polypropylene-based adhesive, designated SA-15-F, which was melt sprayed onto the meltblown elastic web at 2 g/m² add-on level. The adhesive included about 18 wt % P1023 polypropylene material, about 15 wt % EXXON PP3746G, about 50 wt % ESCOREZ 5690 tackifier, about 4 wt % DPX-584 elastomer, and about 13 wt % ESCORENE UL 7710. The ingredients of the adhesive were blended batch-wise until uniform in a commercially available SIGMA blade mixer, which can be obtained from Baker Perkins, Inc., a business having offices located in Peterborough, England.

The employed polypropylene-based adhesive helped to reduce the “rubbery” feel of the elastomeric-substrate, and make the nonwoven composite web (20) more cloth-like and more suitable for use as inner liner layer. In a particular study, it was found that a male “hook” component of a mechanical fastener could better engage the side of the composite web having the applied distribution of polypropylene-based adhesive, as compared to the side of the composite web that did not have the applied layer of polypropylene-based adhesive.

The final coated, composite elastic web (20) could be stretched up to 200 percent or more in both the machine and cross-machine directions, without abrupt rupture or damage to coating layer or the meltblown elastic web. Descriptions of samples A and B of the elastomeric substrate (22) are set forth in the following Table 1.

TABLE 1

| Sample | | MB Basis | MB Spray | Adhesive |
|---|---|---|---|---|
| ID | Elastomeric MB Web | weight | Adhesive | Add-on |
| A | 80/20; KRATON | 1.5 osy | N/A | N/A |
| | G6631/EXACT 0230 | (51 g/m²) | | |
| B | 80/20; KRATON | 1.5 osy | SA-15-F | 2 g/m² |
| | G6631/EXACT 0230 | (51 g/m²) | | |

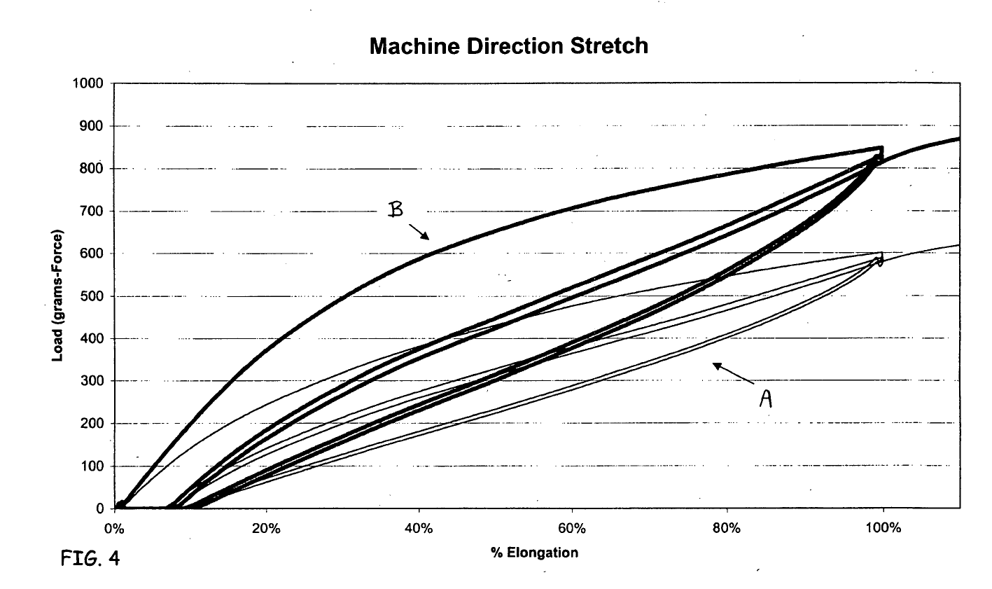

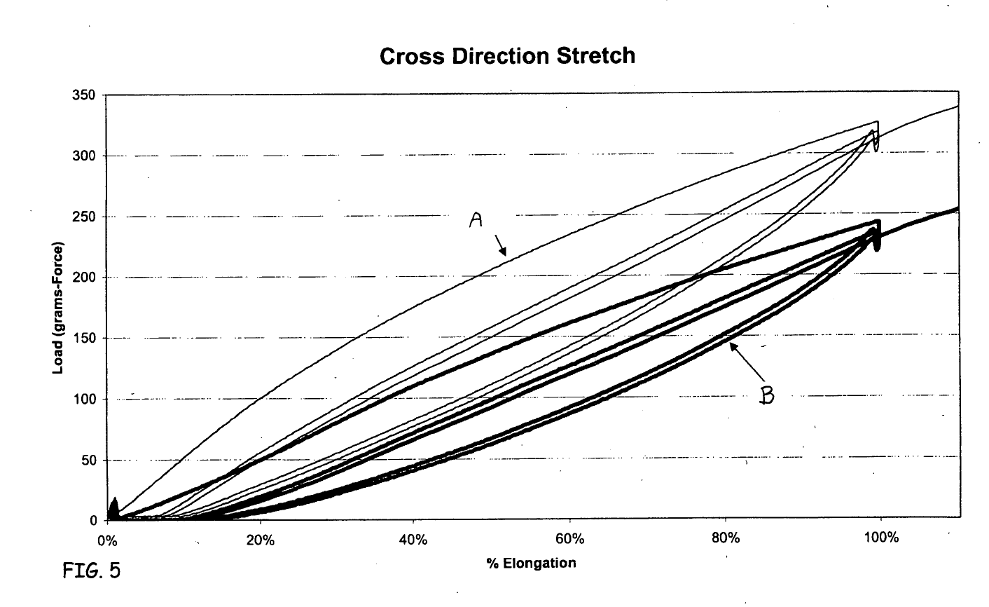

An elastomeric composite web (20) was subjected to a Stress-Strain Cycle Test (2 cycles to 100% elongation, 3rd elongation to break). The results of the stress-strain cycle testing are set forth in the following Table 2, and in FIG. 4 (stretching along the machine-direction) and FIG. 5 (stretching along the cross-direction).

TABLE 2
2^{nd} Cycle Hysterisis & Set Data

| Sample ID | MD % Hyst. | CD % Hyst. | MD % Set | CD % Set |
|---|---|---|---|---|
| A | 24.3% | 23.9% | 10.4% | 10.8% |
| B | 24.9% | 24.8% | 11.6% | 18.0% |

From the stress-strain cycle test data (e.g. representatively-shown in Table 2 and FIGS. 4 and 5), one can observe that the coated webs are biaxially stretchable and elastic in both the machine and cross directions Additionally, a higher machine direction stiffness or initial modulus is observed, accompanied by a maintenance of the hysteresis-loss and permanent-set properties.

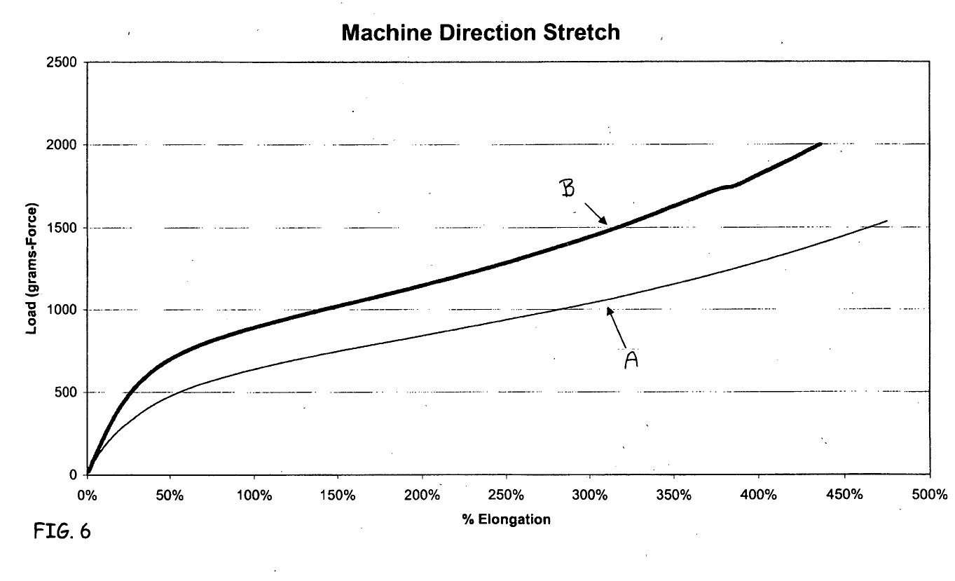

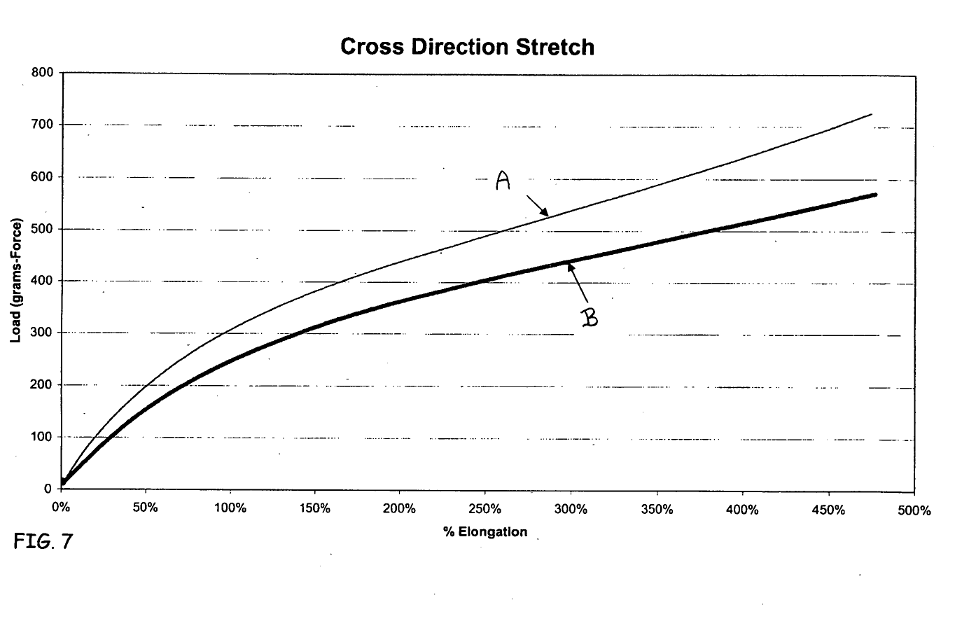

An elastomeric composite web was subjected to a Stress-Strain Elongation to 2000 g Test. The results of the Stress-Strain Elongation test are set forth in FIG. 6 (stretching along the machine-direction), and FIG. 7 (stretching along the cross-direction).

From the Stress-Strain Elongation test, one can observe that the coating of the surface modifying agent is extendable, and can operatively stretch with the elastomeric-substrate due to its fibrous configuration. One can also observe that an excessive, severe rupture of the coating layer does not occur.

An elastomeric composite web (20) was subjected to a Stress-Relation Test (50% Elongation for 30 minutes). The results of the Stress-Relaxation test are set forth in the following Table 3.

TABLE 3
% Loss of Stress at 50% Elongation for 30 Minutes

| Sample ID | MD, % Loss |
|---|---|
| A | 29.4% |
| B | 28.4% |

From the representatively shown data from the Stress-Relaxation test, one can observe that the machine-direction stress relaxation loss is not excessively degraded by the incorporation of the coating layer.

Four codes of the elastomeric composite web (20) were subjected to Static Coefficient of Friction (COF) Measurements. Data from the three codes are summarized in the following Tables 4, 5 and 6.

TABLE 4
COF Data (n = 4 replicates per sample code)

| | Static COF; | |
|---|---|---|
| Sample ID | Average | Std. Dev. |
| A (Smooth-side, untreated-Control web) | 2.041 (A1) | 0.040 |
| A (Wire-side, untreated-Control web) | 1.852 (A2) | 0.073 |
| B (Uncoated Smooth Side; Treated web) | 2.069 (B1) | 0.085 |
| B (Coated Wire-Side; Treated web) | 1.726 (B2) | 0.116 |

TABLE 5
Delta (% difference) in COF:
Smooth-side vs. wire-side of an untreated-control Web A;
Uncoated smooth-side vs. coated wire-side of a treated Web B

| Sample ID | Delta Static COF; Average |
|---|---|
| A | 9.3%: [e.g. 100 * (A1 − A2) ÷ (A1)] |
| B | 16.6%: [e.g. 100 * (B1 − B2) ÷ (B1)] |

TABLE 6
Delta (difference) in COF:
Uncoated smooth-side of an untreated-control web vs. uncoated
smooth-side of the treated web;
Uncoated wire-side of untreated control web vs. coated wire-side
of treated web.

| | Delta Static COF; Average |
|---|---|
| Smooth | −1.4%: [e.g. 100 * (A1 − B1) ÷ (A1)] |
| Wire | 6.8%: [e.g. 100 * (A2 − B2) ÷ (A2)] |

From the static coefficient of friction measurements, one can observe that the incorporation of the coating of the surface modifying agent can provide an ability to tailor the static COF of the elastomeric web to suit the performance properties desired for a given application. In a particular feature, the uncoated and coated sides of a treated web can exhibit a significant differential in static coefficient of friction. As illustrated by the representatively shown example of the styrenic block-copolymer based, elastomeric, nonwoven fabric web, the coated wire-side of the treated web B had a static COF which was reduced by about 6.8%, as compared to the uncoated wire-side of the untreated control web A. In contrast, the uncoated smooth-side of the treated web B had a static COF that differed by a negligible amount, as compared to the static COF of the uncoated smooth-side of the untreated control web A.

One can further observe that the elastomeric-substrate (e.g. the representative, styrenic block-copolymer based, elastomeric, nonwoven fabric web) in the untreated (uncoated) control sample “A” had a relatively small difference in static COF of about 9.3%, when comparing the two opposed sides of the untreated web. In contrast, the similar but distinctively treated substrate web in sample “B” was made less “rubbery” on its coated side. The coated side of the treated web of sample B exhibited a significantly large percentage difference in static COF of about 16.6%, as compared to the uncoated side of the treated web B. Accordingly, the coated side of the treated web B exhibited a static COF which was low enough and a tactile feel which was “soft” enough, to make the coated-side of the treated web suitable for placement directly against the skin of a user. Such placement may, for example, occur when the treated web of the invention is operatively configured as a topsheet liner layer in a protective cover, an item of protective outerwear, or a personal care article, such as a diaper, training pant, adult incontinence article or feminine care article.

### EXAMPLE 2

A meltblown, elastic topsheet, liner layer was also successfully made from a thermoplastic polyurethane material supplied from BASF. The ELASTOLLAN SP-806-10 elastomer material is available from BASF Corporation, a business having offices located in Wyandotte, Mich., U.S.A. A single screw extruder was used to process the polymer. From the meltblown bank, ELASTOLLAN SP-806-10 polymer, having been pre-dried for over 4 hours at 175° F. (80° C.), was meltblown onto a forming wire (belt) at about 4.5 fpm (about 1.4 m/min) for a first web and at about 9 fpm (about 2.7 m/min) for a second web. The meltblown extruder had a melt, hose and die temperature of between about 390-540° F. and air temperature of about 480-520° F. (30 psi both sides), with a single screw speed of 5 rpm. The height of the meltblown die above the forming wire was about 15 inches. No additional bonding was used to form the meltblown elastic nonwoven web. The produced elastic nonwoven web was wound onto a core under minimal tension, having a final measured basis weight of about first web at 3.0 osy (101.73 gsm) and a second web at 1.50 osy (50.87 gsm).

In a separate process, the two elastic meltblown webs were coated using either a polypropylene-based adhesive, designated SA-15-F, or a REXTAC APAO adhesive. The selected coating material was sprayed onto the meltblown elastic webs by employing a meltblown adhesive spray from a grid melter. The melt, hose and die temperature were 340-360° F. (171.1-182.2° C.), and meltblown spray was applied onto web without employing a pressure nip. The meltblown elastic web was supported by a conveyor nonwoven spunbond sheet for movement through the coating process and at 41-123 fpm (about 12.5-37.5 m/min), and the coated web was then wound onto a core at minimal tension. The final coated elastic laminates could be stretched up to 200 percent or more in both the machine-direction and cross-machine direction, without abrupt rupture or excessive damage to either the coating layer or the meltblown elastic web.

Three codes of the elastomeric composite web 20 were subjected to Surface Energy Measurements. The compositions and configurations of the three codes E, F and G are summarized in the following Table 7.

TABLE 7
Code Descriptions

| Sample | | MB Basis | MB Spray | Adhesive |
|---|---|---|---|---|
| ID | Elastomeric MB Web | weight | Adhesive | Add-on |
| E | ELASTOLLAN SP-806-10 | 3.0 osy | SA-15-F | 1 g/m² |
| | (TPU) | (102 g/m²) | | |
| F | ELASTOLLAN SP-806-10 | 3.0 osy | SA-15-F | 3 g/m² |
| | (TPU) | (102 g/m²) | | |
| G | ELASTOLLAN SP-806-10 | 1.5 osy | REXTAC | 1 g/m² |
| | (TPU) | (51 g/m²) | 2115 | |

Contact angles were measured to provide information for the surface energy measurements, and the measured contact angles are set forth in the following Table 8 and Table 8A.

TABLE 8
Contact Angle Values with Water

| | | | Sample | Sample | Sample | Sample |
|---|---|---|---|---|---|---|
| | | | F | F Un- | G | G Un- |
| | Sample E | Sample E | Coated | coated | Coated | coated |
| | Coated | Uncoated | Side | Side | Side | Side |
| | Side | Side | (de- | (de- | (de- | (de- |
| Drop # | (degrees) | (degrees) | grees) | grees) | grees) | grees) |
| 1 | 106.9 | 99.8 | 111.1 | 99.8 | 105.9 | 97.8 |
| 2 | 107.0 | 99.5 | 110.0 | 100.7 | 105.5 | 99.4 |
| 3 | 107.0 | 100.3 | 111.5 | 100.5 | 104.9 | 97.5 |
| 4 | 106.9 | 98.9 | 111.1 | 100.8 | 105.9 | 98.0 |
| 5 | 106.0 | 98.9 | 110.2 | 101.0 | 105.0 | 98.2 |
| 6 | 107.0 | 99.8 | 111.7 | 101.7 | 105.6 | 97.9 |
| 7 | 107.4 | 99.2 | 110.1 | 100.9 | 105.5 | 97.5 |
| 8 | 106.7 | 100.4 | 111.7 | 101.0 | 106.3 | 97.5 |
| 9 | 105.9 | 100.5 | 111.3 | 101.5 | 105.1 | 97.5 |
| 10 | 106.8 | 99.4 | 110.9 | 100.4 | 105.0 | 99.0 |
| Average | 106.8 | 99.7 | 111.0 | 100.8 | 105.5 | 98.0 |
| Std. Dev. | 0.5 | 0.6 | 0.6 | 0.5 | 0.5 | 0.7 |

TABLE 8A
Contact Angle Values with Ethylene Glycol

| | | | Sample | Sample | Sample | Sample |
|---|---|---|---|---|---|---|
| | | | F | F Un- | G | G Un- |
| | Sample E | Sample E | Coated | coated | Coated | coated |
| | Coated | Uncoated | Side | Side | Side | Side |
| | Side | Side | (de- | (de- | (de- | (de- |
| Drop # | (degrees) | (degrees) | grees) | grees) | grees) | grees) |
| 1 | 87.1 | 79.4 | 91.1 | 80.2 | 85.6 | 76.7 |
| 2 | 86.3 | 78.6 | 91.8 | 80.0 | 86.7 | 76.4 |
| 3 | 86.5 | 78.5 | 91.5 | 80.7 | 85.2 | 77.2 |
| 4 | 87.9 | 79.1 | 91.7 | 80.0 | 85.7 | 76.0 |
| 5 | 87.7 | 79.6 | 91.3 | 80.9 | 85.6 | 77.4 |
| 6 | 87.6 | 78.8 | 91.2 | 80.1 | 84.9 | 77.2 |
| 7 | 86.7 | 78.8 | 91.5 | 80.8 | 86.2 | 76.1 |
| 8 | 87.4 | 78.0 | 92.0 | 81.0 | 86.2 | 77.1 |
| 9 | 86.6 | 78.9 | 93.0 | 79.2 | 85.1 | 76.7 |
| 10 | 87.8 | 79.7 | 92.5 | 80.4 | 86.1 | 77.0 |
| Average | 87.2 | 78.9 | 91.8 | 80.3 | 85.7 | 76.8 |
| Std. Dev. | 0.6 | 0.5 | 0.6 | 0.5 | 0.6 | 0.5 |

Particular properties of the probe liquids are summarized in the following Table 8B:

TABLE 8B

| | Overall | | | |
|---|---|---|---|---|
| | Surface | Polar | Dispersive | Surface |
| | Tension | Component | Component | Polarity |
| Liquid | (mN/m) | (mN/m) | (mN/m) | (%) |
| Water | 72.8 | 46.4 | 26.4 | 63.7 |
| Ethylene Glycol | 47.7 | 21.3 | 26.4 | 44.7 |

Employing the resultant contact angle data in combination with the Fowkes method of surface energy determination, the surface energy data set forth in the following Table 8C were determined.

TABLE 8C

| | Overall | | | |
|---|---|---|---|---|
| | Surface | Polar | Dispersive | Surface |
| | Tension | Component | Component | Polarity |
| Surface Energy | (mN/m) | (mN/m) | (mN/m) | (%) |
| Sample E Coated Side | 20.54 | 0.16 | 20.38 | 0.76 |
| Sample E Uncoated Side | 23.62 | 0.69 | 22.93 | 2.93 |
| Sample F Coated Side | 19.30 | 0.01 | 19.29 | 0.07 |
| Sample F Uncoated Side | 22.92 | 0.61 | 22.31 | 2.65 |
| Sample G Coated Side | 21.07 | 0.22 | 20.85 | 1.05 |
| Sample G Uncoated Side | 24.56 | 0.86 | 23.70 | 3.51 |

From the surface energy measurements, one can observe that the coating of the surface modifying agent (e.g. polypropylene-based adhesive material) can provide an ability to tailor the surface energy of the elastomeric web to suit the desired performance properties desired for a given application. In the representatively shown example, the elastomeric thermoplastic polyurethane web was made more hydrophobic as a result of the coating process. In analyzing this data one can note that the coated side of each sample exhibited a relatively lower overall surface energy and surface polarity, as compared to uncoated side of the corresponding web substrate. One can also note the following trend amongst the samples in terms of both overall surface energy and surface polarity (with the trend being observed with regard to both sides of the sample): G>E>F. The inventive, coated composite web materials having lower surface energy, or more hydrophobic properties can better perform when configured as a barrier to isolate a user's skin from bodily fluids such as urine and runny feces.

It should be readily appreciated that modifications and variations to the present invention may be practiced by those of ordinary skill in the art, without departing from the spirit and scope of the present invention, which is more particularly set forth in the appended claims. It should also be understood that the aspects and features of the various configurations may be interchanged, both in whole or in part. Furthermore, those of ordinary skill in the art should appreciate that the foregoing description is by way of example only, and is not intended to add limitations beyond those set forth in the appended claims.

1. An elastomeric composite web comprising
an elastomeric-substrate; and
an operative layer of a surface modifying agent which is applied directly to at least one major, facing-side of the elastomeric-substrate;
wherein
the layer of surface modifying agent has been provided separate from the elastomeric-substrate;
the layer of surface modifying agent has been adhered directly to the elastomeric-substrate while the elastomeric-substrate has been operatively configured in a substantially unstretched condition; and
the layer of surface modifying agent has been applied directly to the elastomeric-substrate prior to attaching the elastomeric-substrate to any separately provided, substantially non-elastomeric, supplemental-substrate.

2. An elastomeric composite web as recited in claim 1, wherein the surface modifying agent includes an elastomeric polypropylene-based adhesive material.

3. An elastomeric composite web as recited in claim 1, wherein the elastomeric-substrate has been substantially free of substantially continuous, elastomeric strands along a significant distance of contiguous cross-directional width when the layer of surface modifying agent was applied to the elastomeric-substrate.

4. An elastomeric composite web as recited in claim 1, wherein the material of elastomeric-substrate is substantially-free of the surface modifying agent.

5. An elastomeric composite web as recited in claim 1, wherein the elastomeric composite web has been accumulated into a bulk storage configuration prior to attaching the elastomeric-substrate to any separately provided, substantially non-elastomeric, supplemental-substrate.

6. An elastomeric composite web as recited in claim 1, wherein
the composite web is at least biaxially stretchable along a pair of orthogonal directions; and
in at least each of the biaxial stretch directions, the composite web provides an initial elastomeric stretch of at least about 50% of its relaxed base length (Lo) with a permanent set value of less than 15%.

7. An elastomeric composite web as recited in claim 1, wherein
the composite web is at least biaxially stretchable, and provides a stretch of at least about 50% of its relaxed length in each of its biaxial stretch directions; and
the stretch in at least each of its biaxial stretch directions is provided substantially without rupturing the layer of surface modifying agent.

8. An elastomeric composite web as recited in claim 1, wherein the layer of surface modifying agent includes an elastomeric polypropylene-based adhesive having an adhesive basis weight which is up to a maximum of about 10 g/m².

9. An elastomeric composite web as recited in claim 1, wherein the layer of surface modifying agent includes an elastomeric polypropylene-based adhesive having an adhesive basis weight which is not less than a minimum of about 0.5 g/m².

10. An elastomeric composite web as recited in claim 1, wherein the elastomeric-substrate includes a meltblown fabric of elastomeric fibers.

11. An elastomeric composite web as recited in claim 1, wherein
the elastomeric-substrate includes a meltblown fabric of elastomeric fibers, and
the meltblown fabric of elastomeric fibers has a fabric basis weight which is at least about 5 g/m², and not more than about 100 g/m².

12. An elastomeric composite web as recited in claim 1, wherein the elastomeric-substrate includes an elastomeric film having a film basis weight which is at least about 10 g/m², and not more than about 80 g/m².

13. An elastomeric composite web as recited in claim 1, wherein the elastomeric composite exhibits a percentage of difference in coefficient of friction which is at least about 10%.

14. An elastomeric composite web as recited in claim 1, wherein the elastomeric composite web has a permanent set value of less than 15%, as determined upon relaxation after an initial stretching of the elastomeric composite web to 100% elongation.

15. An elastomeric composite web as recited in claim 1, wherein the layer of surface modifying agent includes an elastomeric polypropylene-based adhesive which is configured in a distributed, reticulated array of melt-sprayed adhesive.

16. An elastomeric composite web as recited in claim 1, wherein the elastomeric polypropylene-based adhesive is a hotmelt adhesive.

17. An elastomeric composite web as recited in claim 1, wherein the elastomeric polypropylene-based adhesive is a hotmelt adhesive which had a melt-temperature that was within the range of about 160-200° C. during application of the polypropylene-based adhesive onto the elastomeric-substrate.

18. An elastomeric composite web as recited in claim 1, wherein the elastomeric polypropylene-based adhesive, in its molten state, had a melt-viscosity of not more than a maximum of about 6000 cP at a temperature of 175° C.

19. An elastomeric composite web as recited in claim 1, wherein the surface modifying agent includes at least one material selected from the group consisting of polyolefins, metallocene polyethylene, metallocene polypropylene, polyacrylate copolymers, ethylene-vinyl acetate copolymers, ethylene-methylacrylate copolymers, ethylene-butylacrylate copolymers, and elastomeric polymers.

20. An elastomeric composite web as recited in claim 1, wherein the surface modifying agent includes a hot melt adhesive, a pure polymer, or a polymer blend, which has been provided by a hot melt or extrusion process.
